(19) United States
(12) Patent Application Publication
(10) Pub. No.: US 2006/0114455 A1
(43) Pub. Date: Jun. 1, 2006

(54) Cassette assemblies for testing devices and methods

(76) Inventors: Michael John Newman, Ware (GB); Thomas Paul Henley, Langford (GB); Yannick Pierre Louis Hourmand, Great Eversden (GB); Jonathan Chua Cheng Lam, Singapore (SG); Tan Chee Boon, Singapore (SG); Bryan Keith Windus-Smith, Elmswell (GB); Neil Kenneth Gair, Inverness (GB); Bryan Tissington, Inverness (GB)

Correspondence Address: Kevin Hubbard;Kagan Binder PLLC, Ste. 200, Maple Island Building, 221 Main Street North, Stillwater, MN, 55082, US

(21) Appl. No.: 11/241,418

(22) Filed: Sep. 30, 2005

Related U.S. Application Data
(60) Provisional application No. 60/615,555, filed on Sep. 30, 2004.

(51) Int. Cl. G01N 1/10

(52) U.S. Cl. 356/246

(57) ABSTRACT

Cassette assemblies for use with analyte measurement systems are provided. A cassette assembly in accordance with the present invention includes a disk that can hold a plurality of test sensors and rotate relative to a hub. Such cassette assemblies include the capability to lock relative rotational movement between the disk and hub when the cassette assembly is outside of an analyte measurement system and allow such movement when installed in the system.

This application claims the benefit of U.S. Provisional Application Ser. No. 60/615,555, filed Sep. 30, 2004, entitled, “TEST SENSOR DISPENSING MECHANISM AND METHOD OF USE,” the entire disclosure of which is incorporated by reference herein for all purposes.

### TECHNICAL FIELD

The present invention relates generally to testing devices for measuring the concentration of an analyte in a fluid sample. More particularly, the present invention relates to cassette assemblies for use with such testing devices for functionally providing a plurality of test sensors or the like to a testing device. The present invention also relates to methods of making and using such cassette assemblies.

### BACKGROUND

Metering systems for measuring an analyte or indicator (e.g., glucose, HbAlc, lactate, cholesterol) in a fluid such as a body fluid (e.g., blood, interstitial fluid (ISF), urine) typically make use of disposable test sensors. A test sensor that is specific for the analyte or indicator of interest may be inserted into a metering system, within which it becomes physically and electrically connected with a measuring circuit of the metering system. Thus, following application of a sample to a test sensor, a measurement result may be obtained providing an indication of the quantity of the analyte or indicator within the sample.

The insertion of a test sensor into a metering system is often a manual operation in which a user of the metering system must transfer a test sensor from a vial or storage container into a connector port of a metering system. The vial in which test sensors are stored provides a controlled atmosphere that is required to preserve the viability of the test sensor. A user of the metering system is therefore required to open the vial, remove a test sensor, and reseal the vial every time a measurement is made. This process can be both time-consuming and cumbersome, depending on the type of vials and metering systems used and may result in poor testing procedures and/or inaccurate test results.

An improvement to these metering systems described above involves using a removable and replaceable cassette or cartridge of test sensors within the metering system. With this improvement, the user is not required to manually transfer a test sensor from a vial to a connector prior to making a measurement. A strip may instead be transferred directly from the cartridge into a test position using some type of manually activated system. This type of system can position a portion of the strip outside the meter casing so that a user can deposit a sample on it.

### SUMMARY

The present invention provides cassette assemblies for use with analyte measurement systems. Generally, a cassette assembly in accordance with the present invention includes a disk that can hold a plurality of test sensors and a hub about which the disk can rotate. In one aspect of the present invention, a cassette assembly comprises a locking mechanism that can prevent relative rotational movement between the hub and disk when the cassette assembly is outside of an analyte measurement system. When installed in such a system, the locking mechanism is disengaged and the disk can rotate relative to the hub. In this way, test sensors positioned in the cassette assembly can be sequentially indexed by a drive device to supply the test sensors to the metering system.

A cassette assembly in accordance with the present invention includes the capability to retain or memorize the position of the next available test sensor relative an analyte measurement system when the cassette assembly is removed from such as system. For example, the hub of a cassette assembly may be keyed to the analyte measurement system. In this way, the cassette assembly can be removed from the analyte measurement system after a portion of its test sensors have been used and subsequently returned to the system in the same relative position it was in when it was removed. That is, cassette assembly can be returned to a drive device so that the next available test sensor can be accessed by the system. This minimizes the possibility of having wasted test sensors, reusing a used test sensor, and having to search for the next available test sensor.

A cassette assembly in accordance with the present invention may also include an anti-reverse function. Such a cassette assembly includes a disk that can rotate in a dispensing direction relative to a hub but not in an opposite rotational direction. Therefore, possible reuse of a test sensor that has been used for a test and returned to the disk for storage and later disposal can be minimized or prevented. Such a cassette assembly may, for example, include a pawl incorporated with the hub that can engage with a tooth of the disk. When the disk is rotated in the dispensing direction the pawl can disengage from the tooth to allow rotation. When rotation of the disk in the reverse direction is attempted, the pawl stays engaged with the tooth thus preventing such rotation. In this way, the pawl and tooth function like a ratchet mechanism. Moreover, a locking function, as noted above, can also be incorporated with such a cassette assembly. For example, disengagement of the pawl can be prevented or stopped therefore preventing rotation of the disk in the dispensing direction.

In one aspect of the present invention, a cassette assembly for use with an analyte measurement system is provided. The cassette assembly comprises a disk, hub, and locking mechanism. The disk can hold a plurality of test sensors and rotate about the hub. The locking mechanism is integrated with the hub and disk and is selectively configurable between a first configuration that prevents relative rotational movement between the hub and disk and a second configuration that allows relative rotational movement between the hub and disk.

In another aspect of the present invention, a cassette assembly having an electronic chip for use with an analyte measurement system is provided. The cassette assembly comprises a disk, hub, and locking mechanism. The disk can hold a plurality of test sensors and rotate about the hub. The locking mechanism is integrated with the hub and disk and is selectively configurable between a first configuration that prevents relative rotational movement between the hub and disk and a second configuration that allows relative rotational movement between the hub and disk. An electronic chip is incorporated with the hub, such as a memory module or smart chip or the like.

In another aspect of the present invention, a method of maintaining the position of a test sensor of a cassette assembly relative to an analyte measurement system when the cassette assembly is removed from the analyte measurement system is provided. The method comprises the steps of: providing an analyte measurement system having a cassette assembly installed therein wherein the cassette assembly comprising a disk and a hub and the disk comprises a test sensor in a storage position rotationally positioned relative to the hub; removing the cassette assembly from the analyte measurement system; and engaging a locking mechanism of the cassette assembly that locks the relative rotational position of the disk and hub.

In another aspect of the present invention, an analyte measurement system is provided. Generally, the analyte measurement system comprises a cassette assembly, an arm, and a carriage. The cassette assembly has a disk rotatably mounted on a hub for providing a plurality of test sensors. The arm is pivotable about the hub and includes a pawl that can drivingly engage a tooth of the disk of the cassette assembly. The carriage includes an engaging device that can engage with the arm during a first movement of the carriage to index the disk of the cassette assembly and thereafter disengage with the arm during a second movement of the carriage.

In yet another aspect of the present invention, a method of indexing a cassette in an analyte measurement system is provided. The method comprises the steps of: providing a rotatable cassette; engaging a tooth of the cassette with a pawl, the pawl having an extension portion; driving a carriage in a first direction toward an end of the extension portion of the pawl; guiding the end of the extension portion of the pawl with a ramp of the carriage while the carriage is driven in the first direction; driving the carriage in a second direction opposite the first direction to engage the end of the extension portion of the pawl with the carriage; and driving the carriage in the second direction to index the cassette with the pawl.

### BRIEF DESCRIPTION OF THE DRAWINGS

These and other features, aspects, and advantages of the present invention will become better understood with regard to the following description, appended claims, and accompanying drawings where:

FIG. 1 is a perspective cutaway view of an exemplary indexing mechanism having an exemplary cassette assembly and drive device that can provide an indexable source of test sensors to a metering system in accordance with the present invention;

FIG. 2 is a perspective cutaway view of the indexing mechanism of FIG. 1, showing the cassette assembly disengaged from the drive device;

FIG. 3 is a perspective view of the cassette assembly of the indexing mechanism of FIGS. 1 and 2 showing in particular a locking mechanism having a pawl engaged with a tooth of a disk of the cassette assembly in accordance with the present invention;

FIG. 4 is an exploded perspective view of the cassette assembly of FIG. 3 showing the disk as having a plurality of chambers for holding plural test sensors and showing the locking mechanism that can be used for locking the rotational position of the disk of the cassette assembly relative to the hub of the locking mechanism when removed from the drive device;

FIG. 5 is a partially cut away perspective view the cassette assembly of FIGS. 2 and 3;

FIG. 6 is a cross-sectional view of the indexing device of FIG. 2 showing the cassette assembly removed from the drive device and locked by the locking mechanism;

FIG. 7 is a cross-sectional view of the indexing device of FIG. 1 showing the cassette assembly installed in the drive device and unlocked by the locking mechanism;

FIG. 8 is a schematic view of the pawl of the locking mechanism of the cassette assembly of FIG. 3 shown with a stopper of the of the locking mechanism in a locking position that prevents the pawl from flexing to allow rotation of the disk relative to the hub of the locking mechanism;

FIG. 9 is a schematic view of the pawl of the locking mechanism of the cassette assembly of FIG. 3 shown with the stopper of the locking mechanism in an unlocked position where the pawl can flex to ride over the tooth of the disk to allow rotation of the disk relative to the hub of the locking mechanism;

FIG. 10 is a schematic view of an indexing mechanism in accordance with the present invention comprising a carriage that has a connector shown carrying a test sensor as partially positioned in a disk of a cassette assembly and that can engage with an indexing wire and pivot an arm for indexing the disk of the cassette assembly relative to the connector;

FIG. 11 is a schematic view of the indexing mechanism of FIG. 10 showing the connector in a position where the test sensor is fully positioned in the disk of the cassette assembly;

FIG. 12 is a schematic view of the indexing mechanism of FIG. 11 showing the connector removed from the disk of the cassette assembly as retracted by the carriage and showing the arm indexing the disk of the cassette assembly as caused to pivot by an indexing wire connecting the arm and carriage;

FIG. 13 is a is a schematic view of the indexing mechanism of FIG. 12 showing the disk of the cassette assembly as indexed by the arm relative to the position of the disk shown in FIG. 11;

FIG. 14 is a perspective view of the indexing wire of the indexing mechanism of FIGS. 10-13;

FIG. 15 is a schematic view of a cam surface of the carriage of the indexing mechanism of FIGS. 10-13 showing a path followed by the indexing wire during at least an indexing movement of the carriage and showing sequential positions of the wire (A-G), in accordance with the present invention;

FIG. 16 is a schematic side view of the indexing mechanism of FIG. 10 showing the carriage in a neutral or home position with respect to the indexing wire;

FIG. 17 is a schematic side view of the indexing mechanism of FIG. 16 showing the carriage moving in a first direction toward the indexing wire and showing the indexing wire riding up a ramp surface of the carriage;

FIG. 18 is a schematic side view of the indexing mechanism of FIG. 17 showing the carriage as moved further along the first direction than in FIG. 17 and wherein the indexing wire has come to rest on an upper landing of the carriage;

FIG. 19 is a schematic side view of the indexing mechanism of FIG. 18 showing the carriage moving in a second direction opposite the first direction and wherein the indexing wire has been captured by a groove of the carriage;

FIG. 20 is a schematic side view of the indexing mechanism of FIG. 19 showing the carriage further along the second direction than in FIG. 19 wherein the indexing wire is pulling a pawl that is engaged with a first tooth of the disk of the cassette assembly and showing the disk as partially indexed;

FIG. 21 is a schematic side view of the indexing mechanism of FIG. 20 showing the carriage further along the second direction than in FIG. 20 wherein the indexing wire has pulled the pawl engaged with the first tooth of the disk of the cassette assembly so that the disk is fully indexed;

FIG. 22 is a schematic side view of the indexing mechanism of FIG. 21 showing the carriage moving in the first direction at least partially under the force of a spring and showing the pawl deflecting as the pawl rides over the first tooth of the disk of the cassette assembly;

FIG. 23 is a schematic side view of the indexing mechanism of FIG. 22 showing the carriage further along the first direction than in FIG. 22 and showing the pawl engaged with a second tooth of the disk of the cassette assembly adjacent to the first tooth;

FIG. 24 is a schematic side view of the indexing mechanism of FIG. 23 showing the carriage further along the first direction than in FIG. 22 and showing the indexing wire partially disengaged from the groove of the carriage;

FIG. 25 is a schematic side view of the indexing mechanism of FIG. 24 showing the carriage further along the first direction than in FIG. 24 and showing the indexing wire disengaged from the groove of the carriage;

FIG. 26 is a schematic side view of the indexing mechanism of FIG. 25 showing the carriage further along the first direction than in FIG. 25 and showing the indexing wire as being guided by a guide surface of the carriage so that the indexing wire can later engage with the ramp surface on a subsequent move of the carriage in the first direction;

FIG. 27 is a schematic side view of the indexing mechanism of FIG. 26 showing the carriage in the neutral position of FIG. 16 with respect to the indexing wire and where the disk of the cassette assembly has been indexed forward by the indexing mechanism;

FIG. 28 is an exploded perspective view of another exemplary cassette assembly in accordance with the present invention and having a locking mechanism;

FIG. 29 is a perspective view of the cassette assembly of FIG. 28 shown in an assembled state;

FIG. 30 is a perspective view the disk of the cassette assembly of FIGS. 28 and 29;

FIG. 31 is an exploded view the disk of the cassette assembly of FIG. 30;

FIG. 32 is a perspective view of a foil covering of the disk of FIG. 31;

FIG. 33 is a perspective view of a body of the disk of FIG. 31 viewed from a first side;

FIG. 34 is a perspective view of the body of the disk of FIG. 31 viewed from a second side;

FIG. 35 is a perspective view of the disk of the cassette showing an aperture having a plurality of locking grooves for engaging with the locking mechanism in accordance with the present invention;

FIG. 36 is a perspective view of a hub of the locking mechanism of the cassette assembly of FIG. 28;

FIG. 37 is a cross-sectional view of the hub of FIG. 36 engaged with the disk of FIG. 35 in a locked configuration in accordance with the present invention;

FIG. 38 is a cross-sectional view of the hub of FIG. 36 disengaged from the disk of FIG. 35 in an unlocked configuration as installed in an indexing device in accordance with the present invention;

FIG. 39 is a perspective view of a hub engaged with a disk of a cassette assembly according to another exemplary embodiment of a locking mechanism in accordance with the present invention;

FIG. 40 is a perspective view of the hub of FIG. 39 showing a pawl that can engage with a tooth of the disk of the cassette assembly of FIG. 39;

FIG. 41 is a cross-sectional view of the cassette assembly shown in FIG. 39 removed from an indexing device showing the hub engaged with the disk of the cassette assembly in a locked configuration in accordance with the present invention;

FIG. 42 is a cross-sectional view of the cassette assembly shown in FIG. 39 as installed in an indexing device and showing the hub disengaged from the disk of the cassette assembly in an unlocked configuration in accordance with the present invention;

FIG. 43 is a top view of the hub shown in FIG. 40 in a locked position in accordance with the present invention;

FIG. 44 is a top view of the hub shown in FIG. 40 in an unlocked position where a tongue of the hub has been lifted so that the pawl can deflect beneath the tongue in accordance with the present invention;

FIG. 45 is a perspective view of a first housing portion and cassette assembly of a metering system in accordance with another exemplary embodiment of the present invention shown having a second housing portion of the metering system removed;

FIG. 46 is a perspective view of the second housing portion of the metering system of FIG. 45 shown relative to the cassette assembly;

FIG. 47 is an exploded view of the cassette assembly shown in FIG. 45 and showing a locking hub in accordance with the present invention;

FIG. 48 is a perspective view of the hub of FIG. 47 in accordance with the present invention;

FIG. 49 is a perspective top view of a post that can engage with the hub shown in FIG. 48 in accordance with the present invention;

FIG. 50 is a schematic, cross sectional views of the hub shown in FIG. 45 in a locked position as removed from the metering system in accordance with the present invention;

FIG. 51 is a schematic, cross sectional view of the hub shown in FIG. 45 as installed in the metering system in accordance with the present invention;

FIG. 52 is a schematic cross-sectional view of the hub shown in FIG. 45 in an unlocked position as installed in the metering system in accordance with the present invention;

FIG. 53 is a schematic cross-sectional view of the hub shown in FIG. 52 and showing a lid portion of the metering system positioned relative to the hub; and

FIG. 54 is a cross-sectional view of a portion of a metering system with the cassette and hub engaged therein as shown in FIG. 45 in accordance with the present invention.

### DETAILED DESCRIPTION

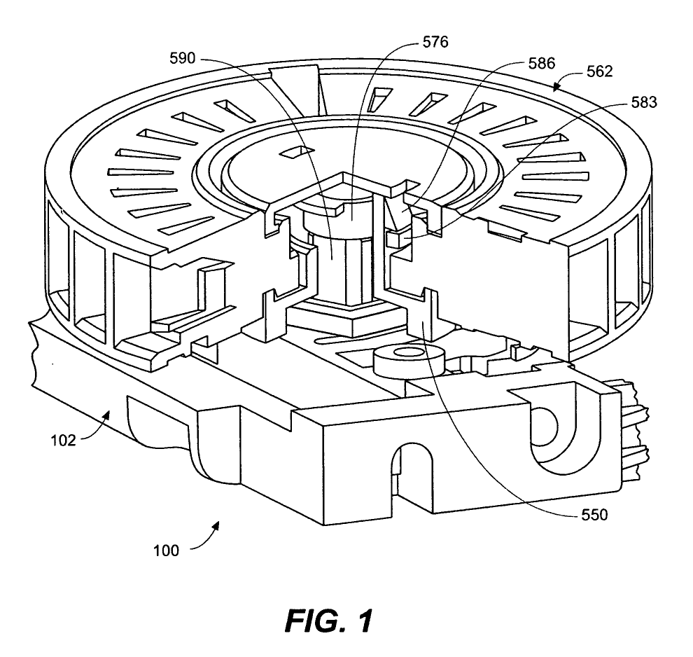

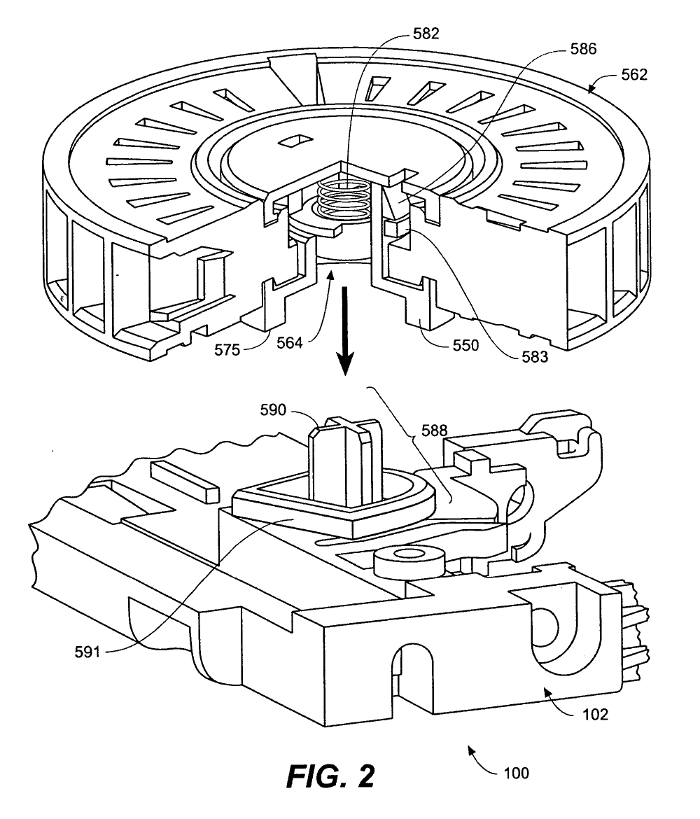

In FIGS. 1 and 2 an exemplary indexing mechanism 100 in accordance with the present invention is illustrated. Indexing mechanism 100 can be integrated with a metering system (not shown) to provide an indexable supply of consumable test sensors, strips, devices, or the like to the metering system. Such metering systems include those used for measuring an analyte in a sample of body fluid such as glucose in blood, for example.

Generally, indexing mechanism 100 comprises cassette assembly 562 for providing a plurality of test sensors to a metering system and drive device 102 that can removably receive cassette assembly 562 and provide a driving function for indexing cassette assembly 562 with respect to a metering system. In FIG. 1, for example, cassette assembly 562 is installed in an operative position with respect to drive device 102 and in FIG. 2 cassette assembly 562 is shown removed from drive device 102. As described in more detail below, in the installed position of FIG. 1, test sensors of cassette assembly 562 can be sequentially indexed by drive device 102 to supply the test sensors to a metering system. An anti-reverse function is also provided in cassette assembly 562 in order to prevent rotation in a direction opposite to a dispensing direction therefore preventing possible reuse of a test sensor. While in the removed position of FIG. 2, cassette assembly 562 includes a feature that allows it to retain or memorize the position of the next available test sensor relative to drive device 102. In this way, cassette assembly 562 can be removed from drive device 102 after a portion of its test sensors have been used and subsequently returned to drive device 102 in the same relative position it was in when it was removed. That is, cassette assembly 562 can be returned to drive device 102 so that the next available test sensor can be accessed by the metering system. This minimizes the possibility of having wasted test sensors, reusing a used test sensor, and having to search for the next available test sensor.

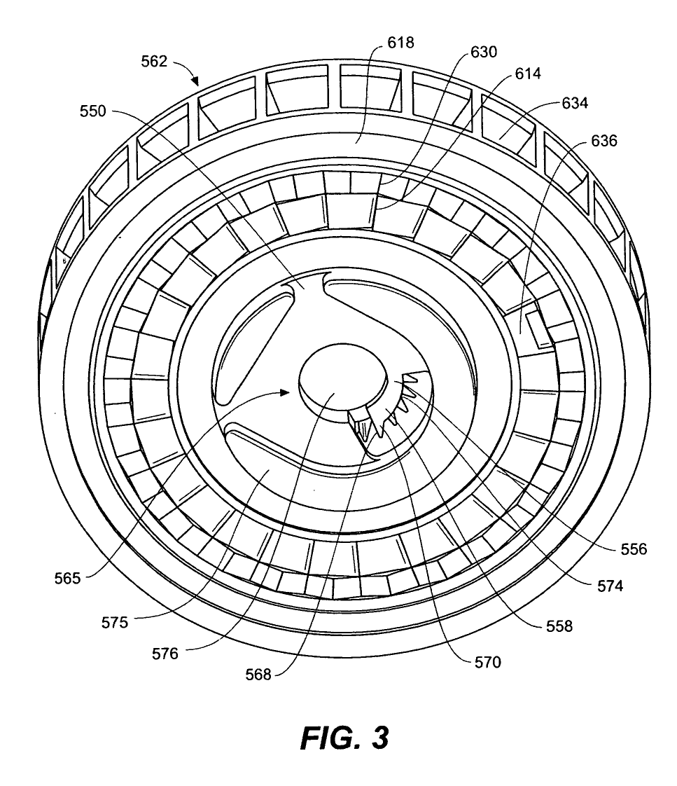

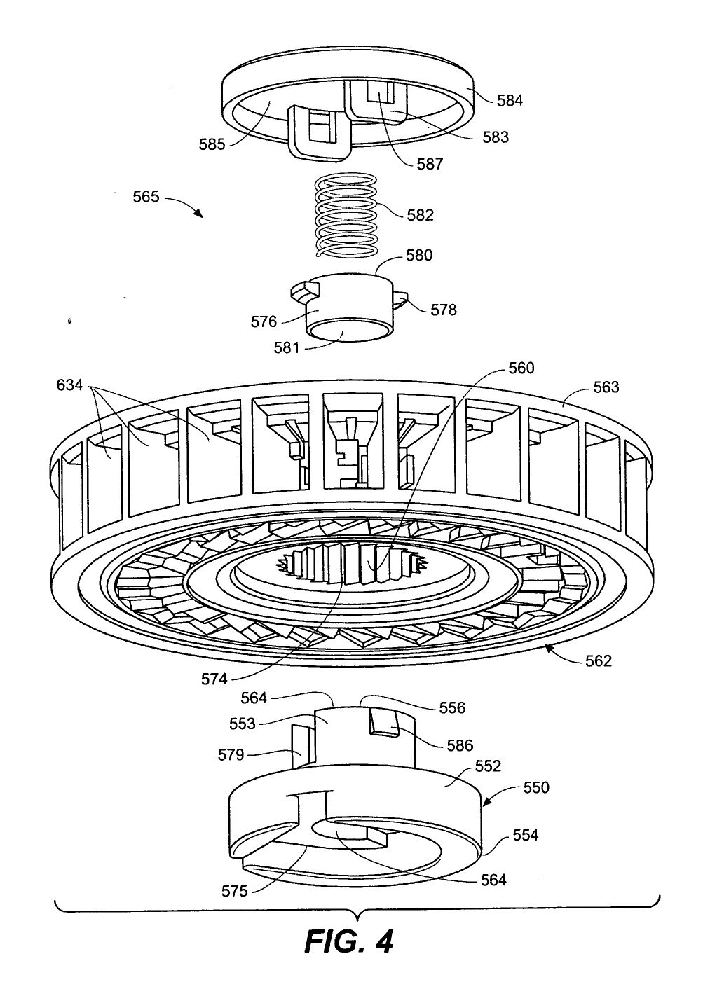

Cassette assembly 562 is shown in more detail in FIGS. 3-5. As best shown in FIG. 4, cassette assembly 562 comprises disk 563 for storing and holding a plurality of test sensors in chambers 634. Cassette assembly 562 also includes locking mechanism 565 that can lock the position of disk 563 with respect to drive device 102 in accordance with the present invention.

As shown, disk 563 includes central aperture 560 for receiving locking mechanism 565. Locking mechanism 565, as shown best in FIG. 4, comprises hub 550, stopper 576, spring 582, and cap 584. When locking mechanism 565 is installed in disk 563, boss 553 of hub 550 is positioned in aperture 560. Likewise, when installed in disk 563, stopper 576 is positioned in central opening 564 of hub 550 so that ears 578 of stopper slidingly engage with slot 579 of boss 553. Also, spring 582 is positioned so that it is at least partially within cavity 580 of stopper 576 and trapped between a wall portion 581 of stopper 576 and surface 585 of cap 584. And, cap 584 is positioned so that opening 587 of arm 583 engages with protrusion 586 of boss 553 of hub 550. When installed, arm 583 flexes so that a snap fit is provided.

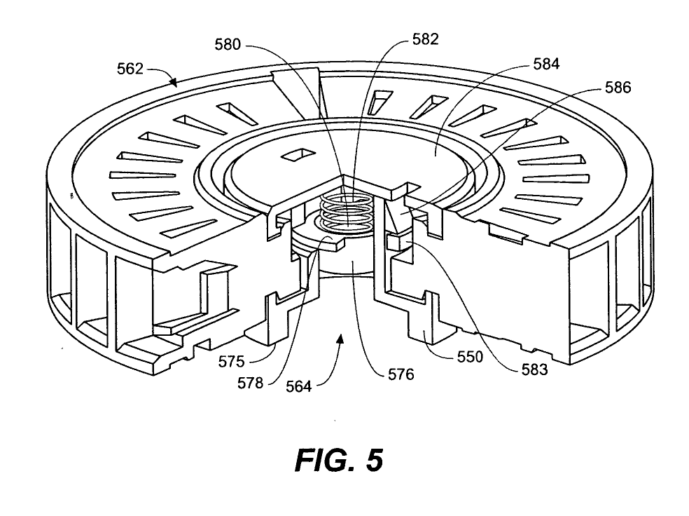

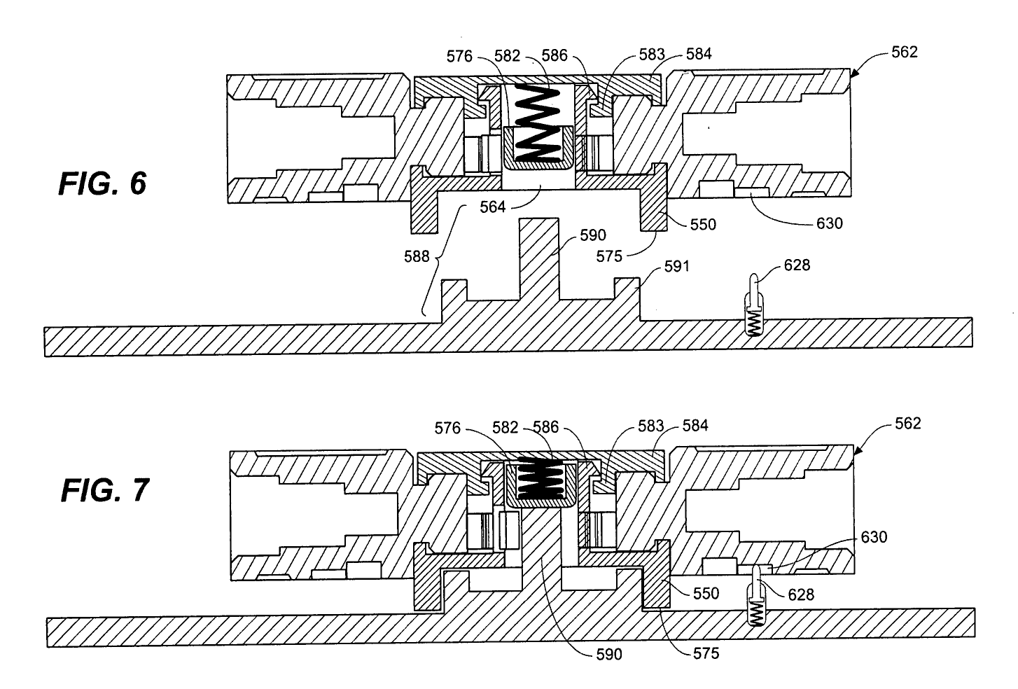

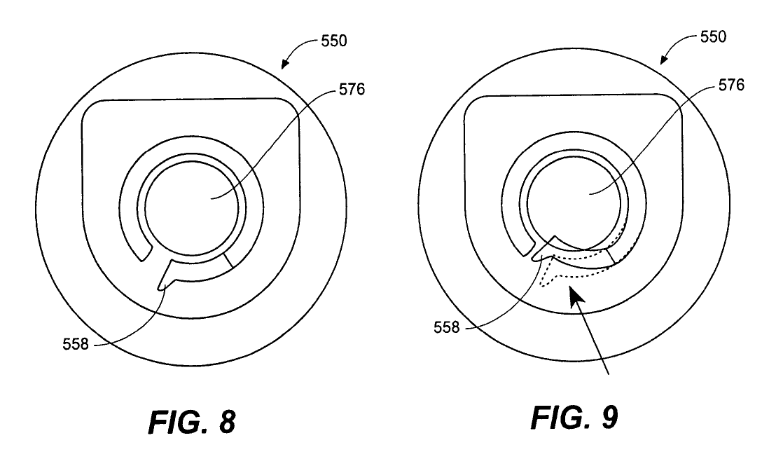

Central aperture 560 of disk 563 includes plural teeth 577 that engage with pawl 558 provided by hub 550 of locking mechanism 565 when hub 550 is installed in disk 563. Pawl 558 can flex with respect to hub 550 and ride over the particular tooth that pawl 558 is engaged with when cassette assembly 562 is installed in drive device 110 and disk 563 is driven to index a test sensor. Teeth 577 and pawl 558 are designed so that only one direction of rotation is possible, thus functioning like a ratchet mechanism. That is, pawl 558 can flex to ride over teeth 577 when disk 563 rotates in one direction (an indexing direction) but not in the reverse direction, thus providing an anti-reverse function. This flexing action of pawl 558 is schematically illustrated in FIG. 9 and described in more detail below. Note that in this position where cassette assembly 562 is installed in drive device 110, stopper 576 is pushed away from pawl 558 by post 590 of drive device 110 against spring 582, as can be seen best in FIG. 7. In contrast, when cassette assembly 562 is removed from drive device 110, as shown in FIGS. 5 and 8, stopper 576 is pushed by spring 582 so that ears 578 bottom out in slots 579 of boss 553 of hub 550. In this position, stopper 576 prevents inward flexing of pawl 558 as shown in FIG. 8. Thus, because pawl 558 cannot flex to ride over teeth 577 due to the position of stopper 576, no relative rotational movement between hub 550 and disk 563 is possible when cassette assembly 562 is removed from drive device 110.

As can be seen in FIG. 3, hub 550 of locking mechanism 565 of cassette assembly 562 includes receiver 575 preferably formed by a D-shaped recessed region of hub 550. Receiver 575 is designed to engage with key 591 of drive device 102, which is similarly D-shaped, as shown in FIG. 2, and comprises a boss or raised portion, as illustrated. When cassette assembly 562 is installed on drive device 102, key 591 fits within receiver 575. Because of the shape of receiver 575 and key 591, hub 550 of locking mechanism 565 will always be positioned on drive device 102 in the same relative orientation with respect to drive device 102. Combined with the locking functionality of the locking mechanism 565 described above, cassette assembly 562 can be removed from drive device 102 and later reinstalled without losing its prior relative position with respect to drive device 102.

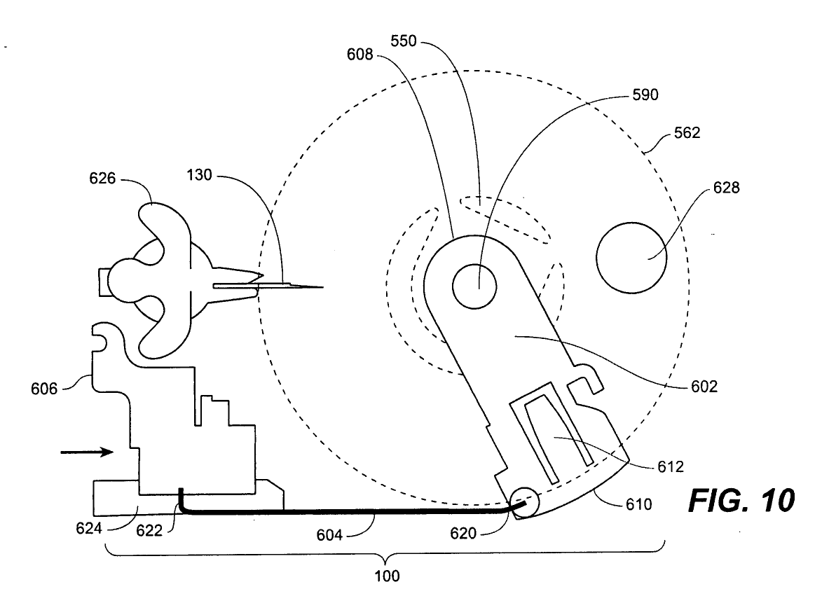

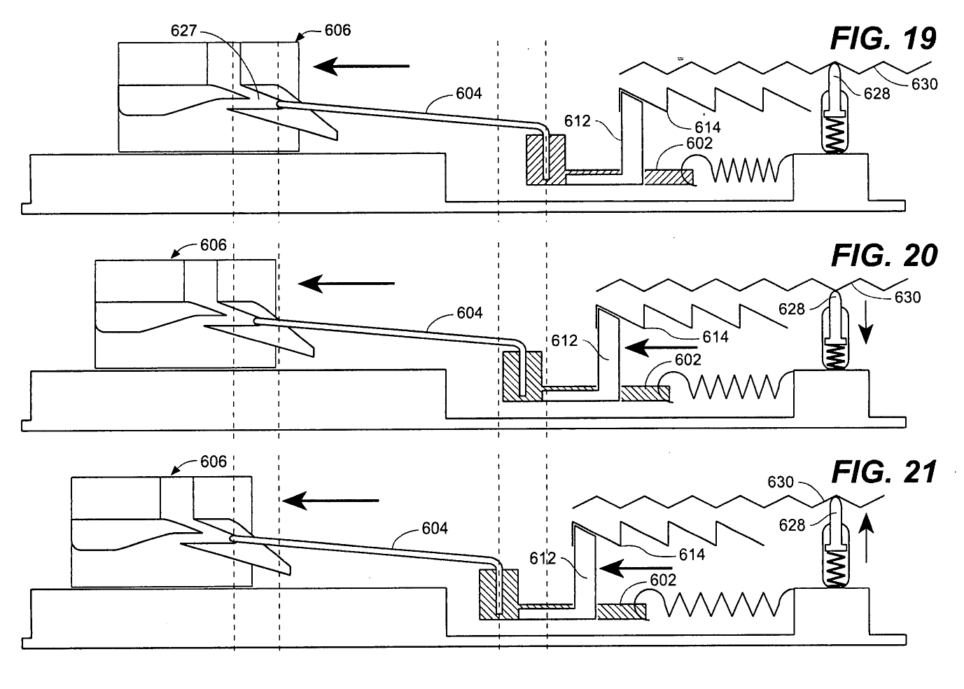

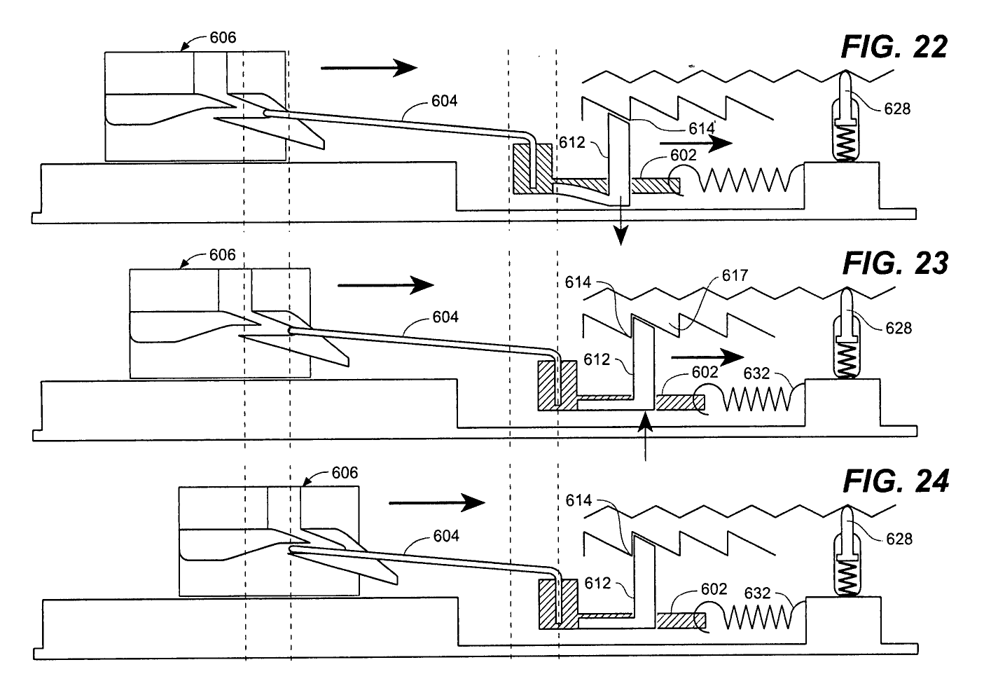

Disk 563 also includes plural drive teeth 614 arranged on a circular path that can be engaged by drive device 110 to drive disk 563 in use. Also, plural indexing teeth 630 are concentrically arranged relative to drive teeth 614 and function to align disk 563 at each index position. As shown, tooth 636 of drive teeth 614 comprises a filled-in tooth that cannot be engaged by drive device 110. Tooth 636 functions to prevent indexing mechanism 100 from positioning disk 563 of cassette assembly 562 at a position where a dummy chamber (like chamber 634 but solid) is located. A solid or filled chamber provides a location to attach a circumferential foil seal or the like. These driving and indexing aspects of the present invention are discussed in more detail below with reference to FIGS. 10-27.

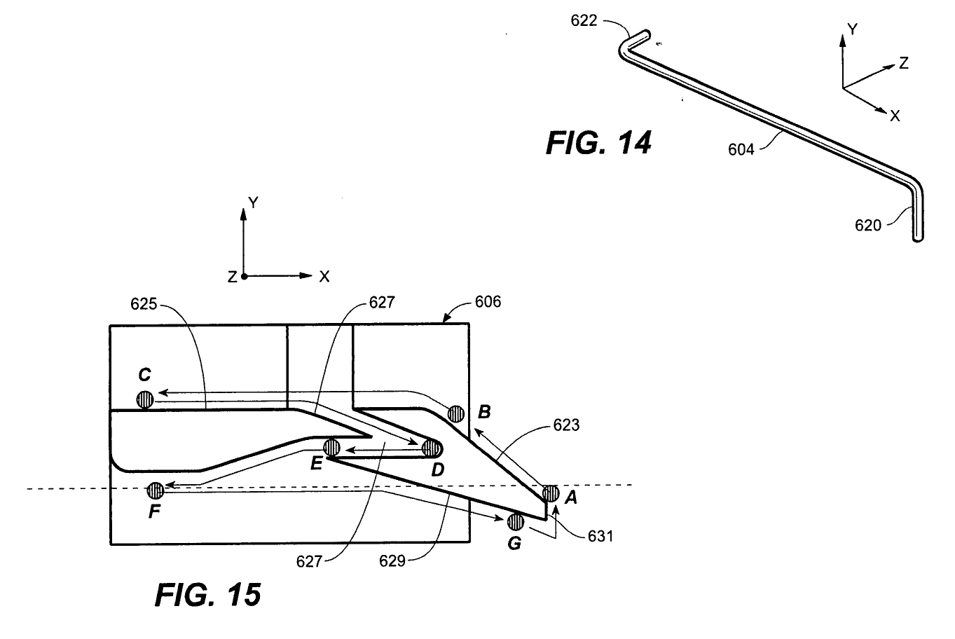

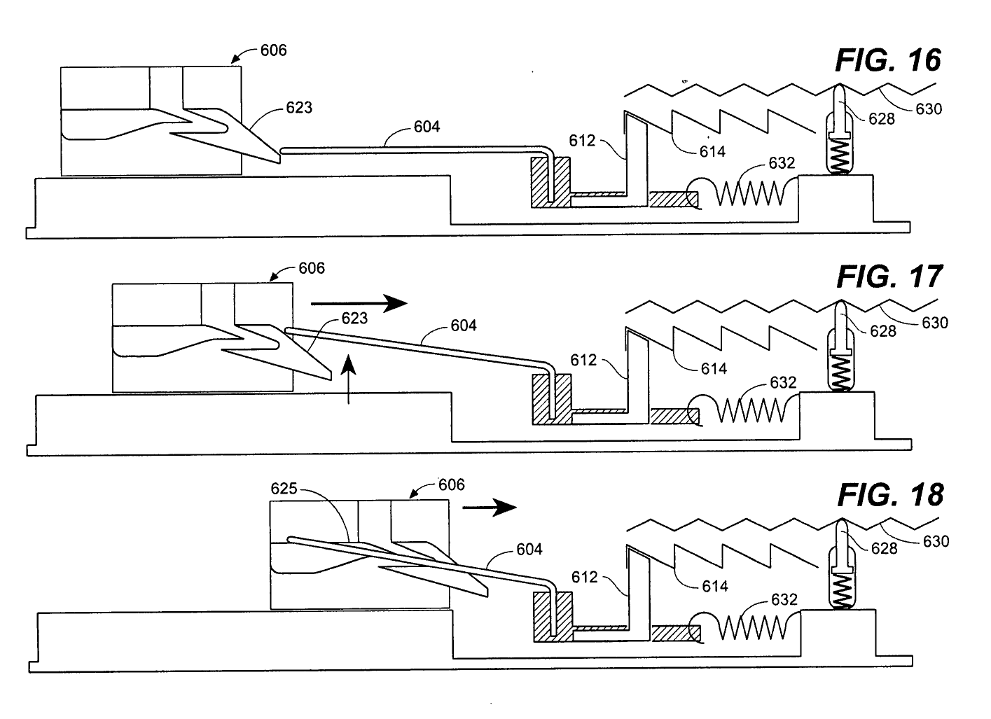

In FIGS. 10-27, indexing mechanism 100 in accordance with the present invention is schematically shown. In each of FIGS. 10-13 a top schematic view of indexing mechanism 100 is shown in various positions during use. In FIGS. 16-27, indexing mechanism 100 is schematically shown from the side. Generally, indexing mechanism 100 includes arm 602, wire 604, and carriage 606 that is moved by a drive device such as a motor (not shown) in a metering system in which indexing mechanism 100 is used. Arm 602 includes proximal end 608, distal end 610 and pawl 612 that engages with drive tooth 614 on lower surface 618 of disk 563 of cassette assembly 562. Arm 602 forms part of meter interface 588 (see FIG. 2) and is pivotably attached to post 590 at proximal end 608 of arm 602. Wire 604 includes first end 620 and second end 622 each of which have an approximately 90 degree bend (see FIG. 14). First end 620 of wire 604 is attached to distal end 610 of arm 602. Second end 622 of wire 604 moves along cam surface 624 (shown in FIG. 15) on carriage 606 as will be described in more detail below.

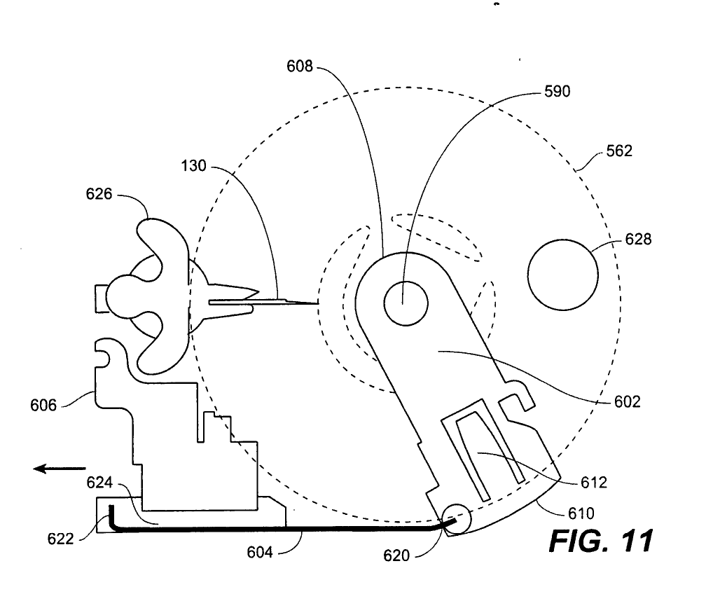

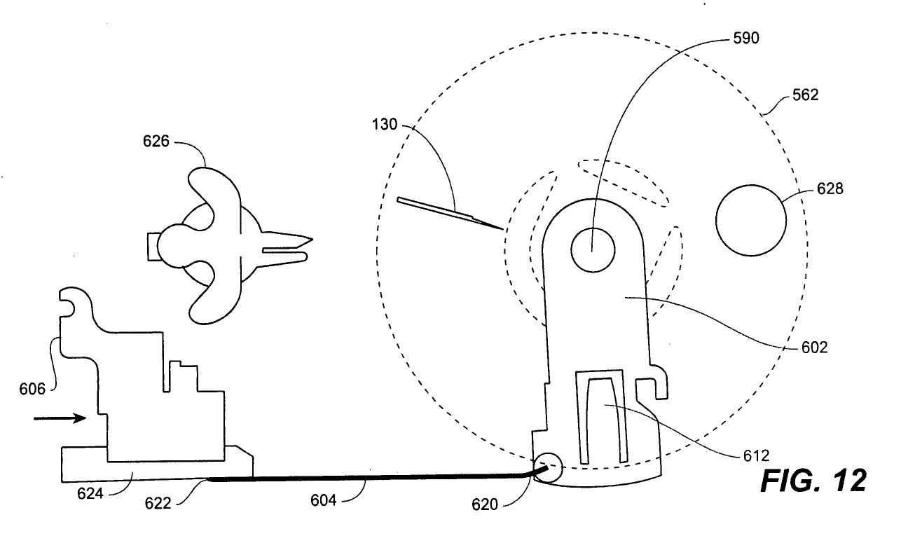

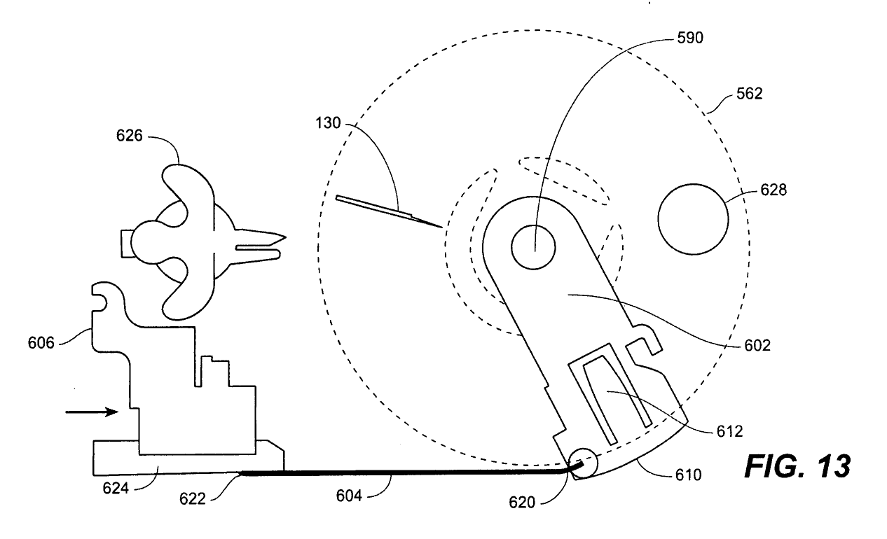

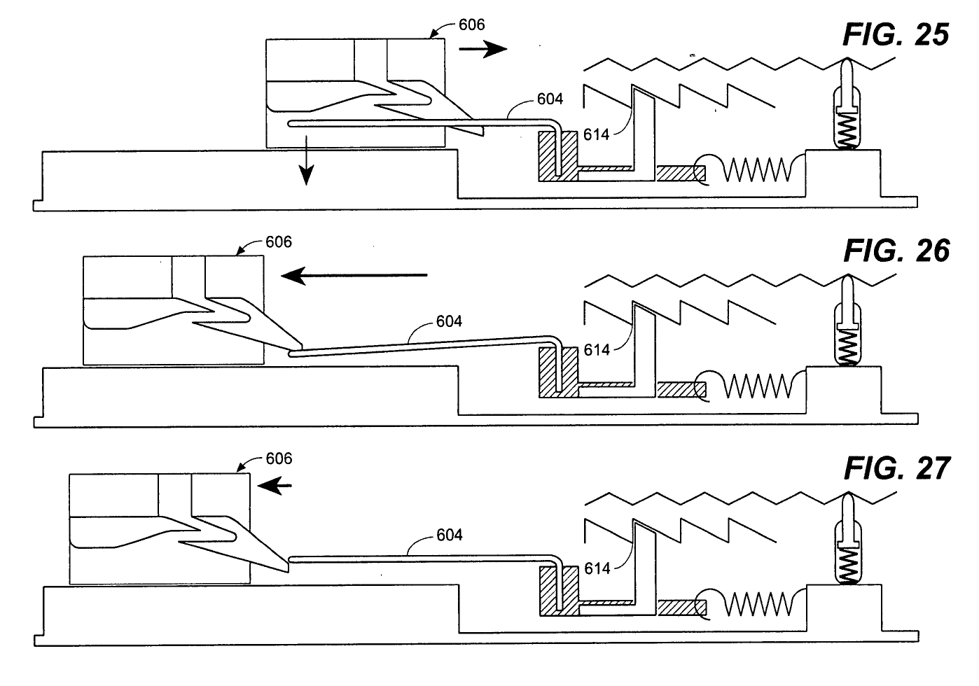

Referring to FIGS. 10-13 and 15-27 together, a sequence of steps for indexing cassette assembly 562 in accordance with the present invention are illustrated. In use a test sensor 130 is removed from cassette assembly 562 by connector 626 and moved to a test position. After test sensor 130 is used, carriage 606 is driven toward cassette assembly 562 to move connector 626 toward cassette assembly 562. As carriage 606 moves toward cassette assembly 562, second end 622 of wire 604 moves on a path from position A to B on ramp surface 623 of carriage 606 (see FIGS. 10, 15-17). In FIG. 11, a used test sensor 130 is shown being returned to cassette assembly 562 by connector 626. At this point, wire 604 will be positioned on landing surface 625 as shown in FIG. 18. Carriage 606 is then moved away from cassette assembly 562, wire 604 moves along landing surface 625 until it falls into groove 627 where it is engaged by carriage 606 at point D, and arm 602 is pulled by wire 604 (see FIGS. 12, 15, and 19). This causes arm 602 to rotate and in turn rotates or indexes cassette assembly 562 by engaging pawl 612 on arm 602 with drive tooth 614 on lower surface 618 of cassette assembly 562 (see FIGS. 20 and 21). Simultaneously, a pin 628 that is spring-loaded moves to a next indexing tooth 630 to place the next unused test sensor 130 in the proper position for extraction from disk 563 of cassette assembly 562 by connector 626. Carriage 606 is next moved toward cassette assembly 562 until wire 604 is almost disengaged from groove 627 at point E, allowing arm 602 to return to its initial position under bias from an arm spring 632 (see FIGS. 13, 15, and 22-24). At this step, pawl 612 in arm 602 can flex to ride over drive tooth 614 to the next tooth 617 (see FIG. 23). Pawl 612 is engaged with a tooth 616 by the bias from arm spring 632 (see FIG. 24). As carriage 606 continues to move toward cassette assembly 562, wire 604 is completely disengaged from carriage 606 at point F (see FIGS. 15 and 25). Carriage 606 is then moved away from cassette assembly 562 so that wire 604 is positioned at point G where a spring load of wire 604 forces wire 604 against surface 629. Continued motion of carriage 606 and spring load of wire 604 causes wire to move around tip portion 631 of carriage back to position A (see FIGS. 15, 26, and 27).

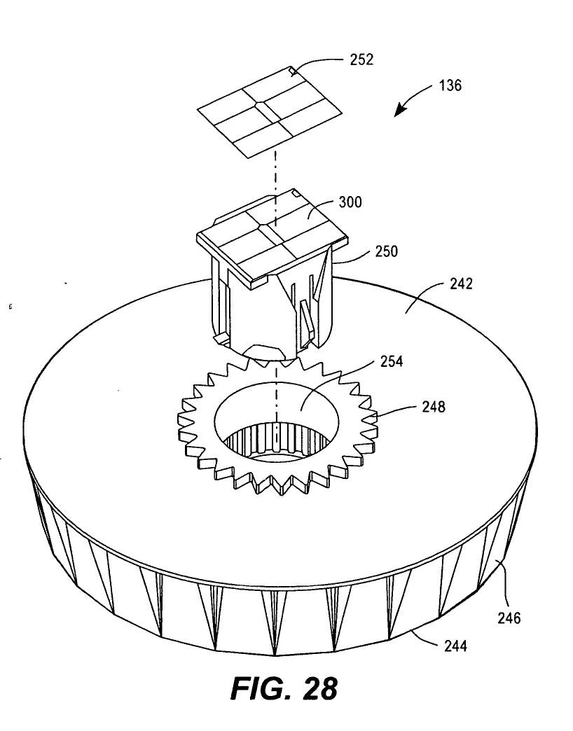

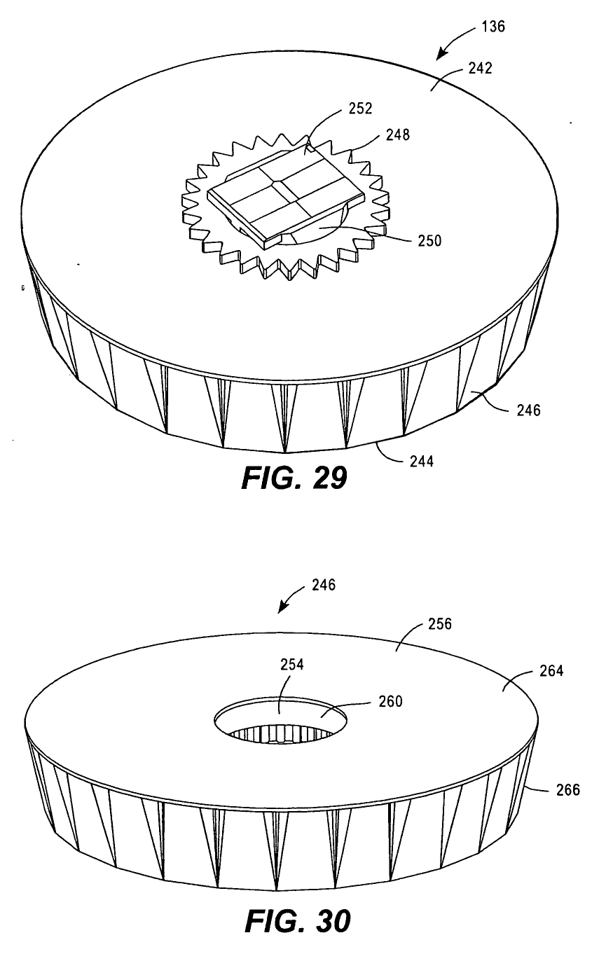

FIGS. 28 and 29 are exploded and perspective views, respectively, of another exemplary cassette assembly 136 in accordance with the present invention. Cassette assembly 136 can provide a replaceable and disposable supply of test sensors to a metering system. Cassette assembly 136 includes lower surface 242, upper surface 244, disk 246, gear teeth 248, hub 250, and preferably memory module 252 or smart chip or the like. Test sensor-specific information including, for example, a calibration code or the like for a plurality of test sensors is housed within disk 246. Such test sensor-specific information can be in a visually readable format (e.g., an indicia), in a machine-readable format (e.g., a bar code or a resistance bridge circuit) or as a radio frequency identity tag (RFID tag) as is described in PCT Application No. GB04/004321 (published on May 6, 2005 as WO 2005/040793 A1; LifeScan Docket number DDI 5008) the disclosure of which is fully incorporated herein by reference for all purposes. However, information is preferably stored in memory module 252 as, for example, a read-only memory (ROM) or a rewriteable memory, such as, for example, an electronically erasable programmable read only memory (EEPROM). In addition to a calibration code, information stored on an EEPROM may include a unique number identifying a cartridge, number of test sensors in a cartridge, expiration date of the cartridge, calibration factors, acceptable performance range(s) and other relevant information.

Hub 250 is removably positionable and rotatably lockable with respect to disk 246 within cassette aperture 254. Memory module 252 is preferably permanently adhered to surface 300 of hub 250 by an adhesive glue, for example, an epoxy or heat-sealed adhesive, as is known to those skilled in the art. When inserted into a metering system, hub 250 with attached memory module 252 rotationally unlocks from cassette assembly 136. Once unlocked, memory module 252 and hub 250 remain stationary with respect to a metering system in which cassette assembly 136 is installed to maintain proper reading orientation with the metering system while disk 246 is free to rotate, as will be described in more detail below.

FIG. 30 is a perspective view of disk 246 of cassette assembly 136 according to an exemplary embodiment of the present invention. Disk 246 is illustrated as a user would receive it for placement in a metering system. Disk 246 is, as shown, cylindrical in shape and includes lower surface 256, upper surface (not shown but generally opposite the lower surface 256), inner surface 260, cassette aperture 254, lower foil covering 264, and upper foil covering 266. To maintain a moisture-free environment and prevent contamination, lower foil covering 264 and upper foil covering 266 are preferably sealed by a process as is known to those skilled in the art, for example, a heat-sealing process.

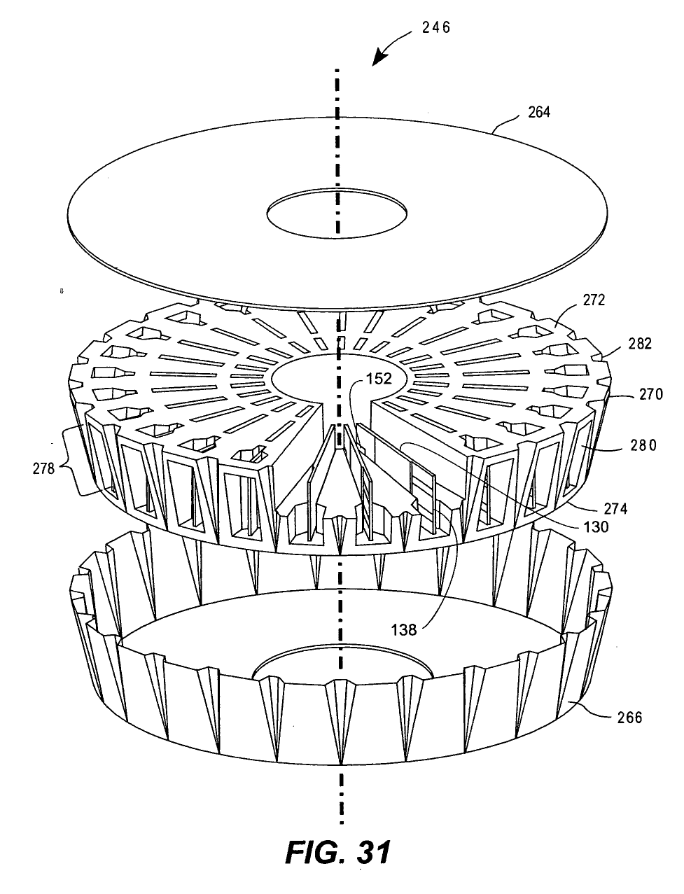

FIG. 31 is an exploded view of disk 246 shown in FIG. 30. Disk 246 further includes body 270. Body 270 is preferably designed to house between about 20 to 50 test sensors 130 with one of test sensors 130 preferably in each of separate chambers 278 as illustrated. Body 270 is preferably made of a rigid injection moldable plastic such as polyethylene or polypropylene and formed into a single unit by one shot injection molding as is known to those skilled in the art. Desiccant can be added to body 270, if desired, as is known to those skilled in the art. Body 270 includes lower surface 272, upper surface 274, radially spaced chambers 278 each including an opening 280, and a plurality of indents 282. Chambers 278 are preferably fabricated to wholly retain test sensors 130 therein, examples of which are disclosed in the U.S. Provisional Application No. 60/516,252 (LifeScan Attorney Docket No. DDI 5016), the entire disclosure of which is incorporated herein by reference for all purposes. The width of each chamber 278 is of sufficient size to removeably retain test sensor 130 on test sensor first longitudinal side (i.e., in an “on-edge” or vertical orientation) with test sensor proximal end 138 extending toward disk chamber opening 280 and fill indicator window 152 extending generally toward cassette aperture 254 (see FIG. 31). While the orientation of test sensor 130 is “on-edge” and the plane of test sensor 130 is approximately perpendicular to upper and lower surfaces 272 and 274 of body 270, other orientations are contemplated.

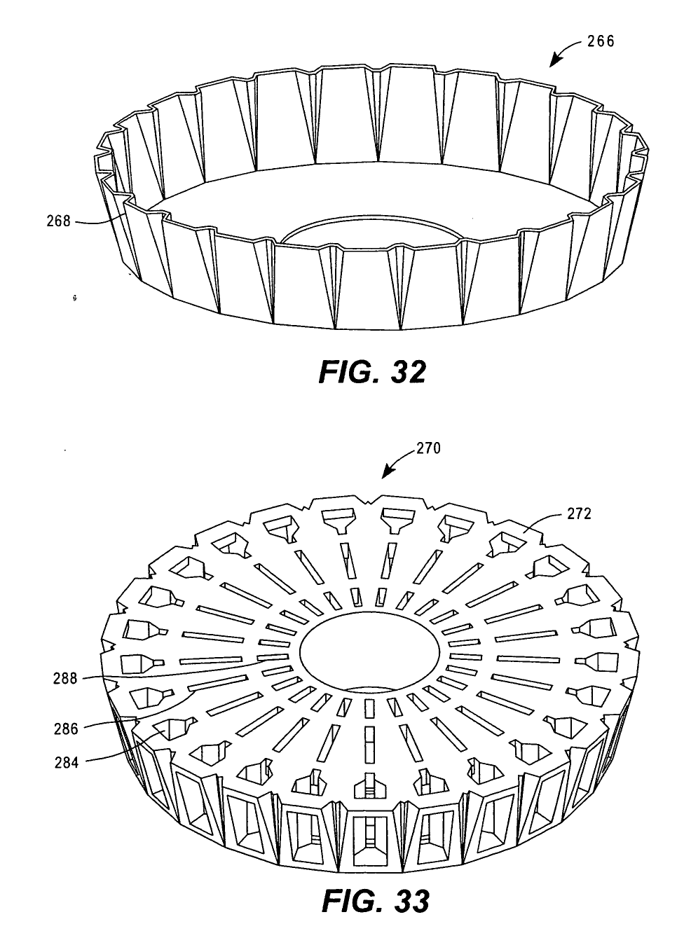

FIG. 32 is a perspective view of upper foil covering 266 of cassette assembly 136 according to an exemplary embodiment of the present invention. Upper foil covering 266 preferably comprises a single sheet of foil that is adhered to body 270 by any process as is known to those skilled in the art, for example, a process using heat-seal adhesive. By such a process, upper foil covering 266 is molded to body 270 such that upper foiling covering 266 has indents 268 that fit into and permanently adhere to correspondingly shaped and distributed indents 282 of body 270.

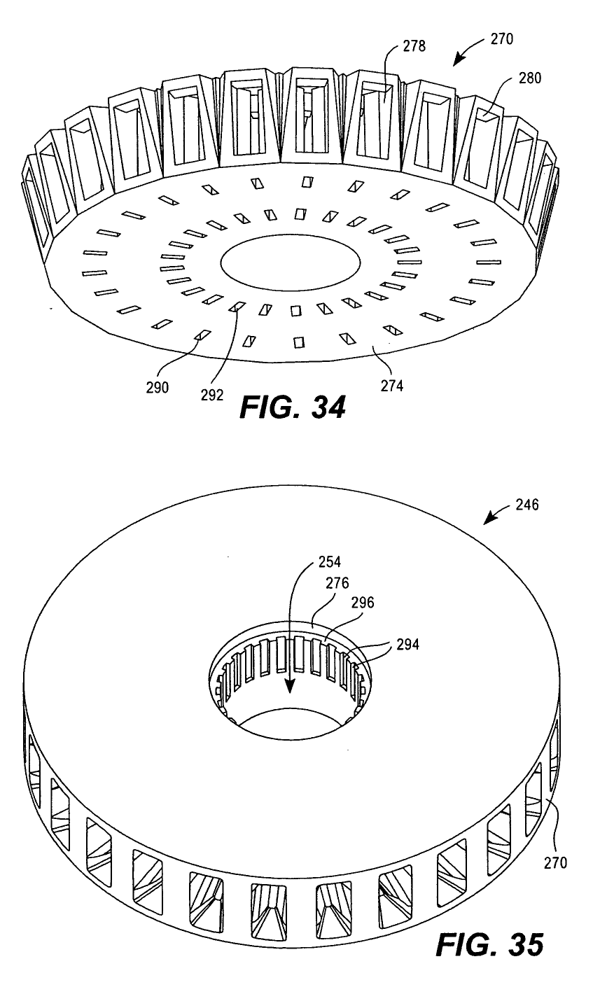

FIGS. 33 and 34 are perspective views of lower surface 272 and upper surface 274, respectively, of body 270 without lower or upper foil coverings 264 and 266, respectively. Lower surface 272 includes first radial holes 284, second radial holes 286 and third radial holes 288. Upper surface 274 includes fourth radial holes 290 and fifth radial holes 292. Radial holes 284, 286, 288, 290 and 292 function to release body 270 from the mold after fabrication. Body 270 may include any number of holes or openings or the like having any desired shape depending on the fabrication parameters or techniques used to form body 270.

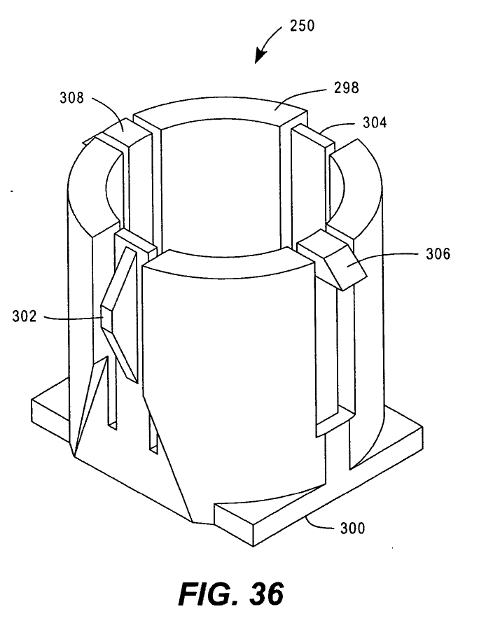

FIG. 35 is a perspective view of disk 246 showing centrally located aperture 254 of body 270. Inner surface 276 of body 270 includes a plurality of axial slots 294 and an inner ledge 296. Axial slots 294 are preferably equally spaced within the inner surface 276 of body 270. Inner ledge 296 is preferably located on lower surface 272 of body 270.

FIG. 36 is a perspective view of hub 250 of cassette assembly 136 in accordance with the present invention. Hub 250 includes a proximal end 298, a distal end 300, two opposing flexible or deflectable arms having slot engaging features 302 and 304 (that function like pawls), and two opposing hub retention clips 306 and 308. In this embodiment, the slot engaging features 302 and 304 and hub retention clips 306 and 308 are preferably radially spaced by approximately 90 degrees. Hub 250 is preferably cylindrical in shape and of sufficient size to fit securely within cassette aperture 254 of body 270. Distal end 300 of hub 250 is preferably rectangular in shape and of sufficient size to wholly retain memory module 252 (see FIGS. 28 and 29) thereon.

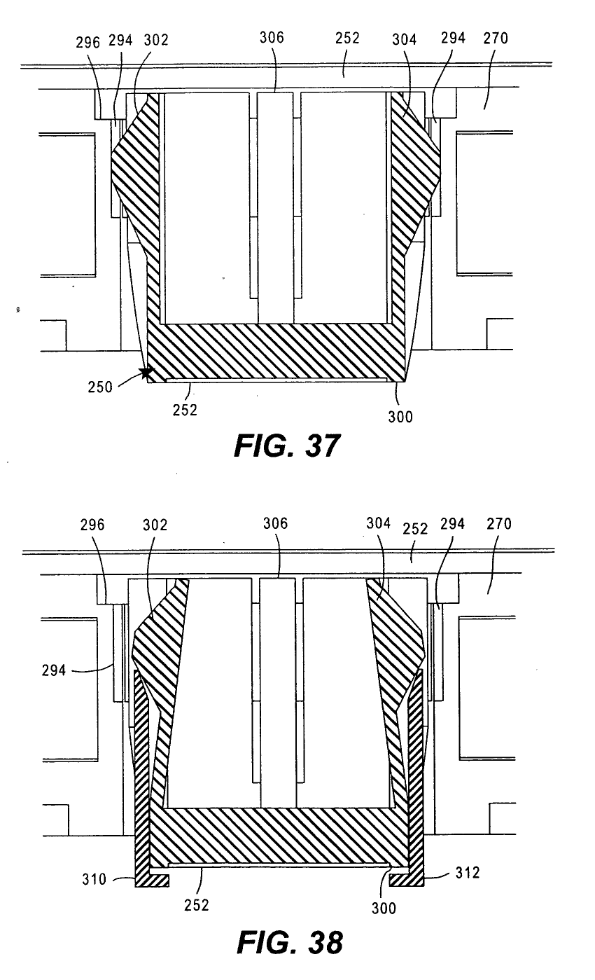

FIG. 37 is a cross-sectional view of hub 250 engaged within cassette assembly 136, thus providing a locking function. When engaged, axial slot engaging features 302 and 304, and hub retention clips 306 and 308 are removeably retained within two opposing axial slots 294 and on inner ledge 296 of body 270, respectively. Thus, features 302 and 304 function like a pawl and slots 294 function as teeth. When engaged, hub 250 prevents body 270 from rotating within cavity 146 of a metering system in where it is used, but allows cassette assembly 136 to be removed from the metering system while retaining mechanical memory of the next unused test sensor positioned in body 270. Such mechanical memory allows cassette assembly 136 to be removed from the metering system and subsequently re-inserted into the metering system in a position where the next unused test sensor will be removed from chamber 278 upon activation of the metering system. Upon re-insertion of hub 250 and cassette assembly 136, memory module 252 remains in the proper reading orientation with the metering system.

FIG. 38 is a cross-sectional view of hub 250 within cassette assembly 136 wherein hub 250 is disengaged or unlocked. Cassette assembly 136 cannot be removed from a metering system without reconnecting hub 250 to cassette assembly 136 within cassette aperture 254. When the hub 250 and cassette assembly 136 are reconnected by re-engaging hub 250 within cassette aperture 254 after a portion of the available test sensors have been used, the relative angular position of hub 250 and cassette assembly 136 will have changed and will be locked. As long as the initial relative angular position is known, the number of test sensors 130 dispensed can be determined by the metering system from cassette assembly 136 itself after removal and subsequent reinsertion into the metering system. In this way mechanical memory is achieved by disengaging hub axial slot engaging features 302 and 304 from body inner surface axial slots 294 (slots 294 may be viewed as an inwardly facing gear) by pushing features 302 and 304 inwards. Hub axial slot engaging features 302 and 304 are flexibly mounted on hub distal end 300. Metering system includes hub releasing features 310 and 312 for pushing hub axial slot engaging features 302 and 304 inwards. Hub retention clips 306 and 308 hold cassette assembly 136 and hub 250 together at all times (a snap fit). When hub axial slot engaging features 302 and 304 are pushed inwards, cassette assembly 136 can rotate relative to hub 250 and the metering system because hub retention clips 306 and 308 slide rotatably along substantially circular inner ledge 296 of body 270 as hub 250 is held stationary. Thus, inner ledge 296 moves past hub retention clips 306 and 308.

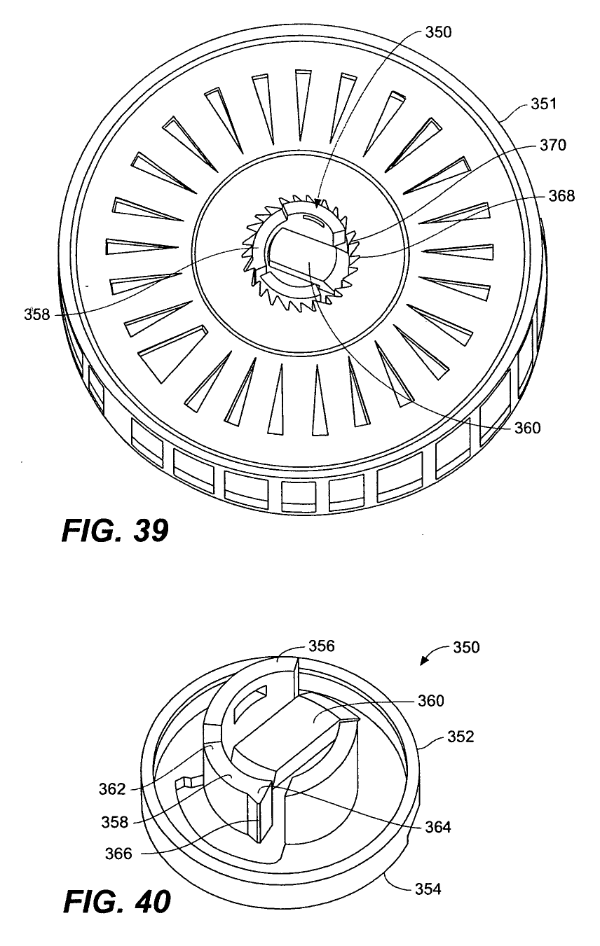

FIG. 39 is a perspective view of hub 350 engaged with a cassette 351 according to another exemplary embodiment of the present invention. Referring to FIG. 40, hub 350 includes a body 352, a proximal end 354, a distal end 356, a pawl 358 and a tongue 360. Hub 350 is preferably cylindrical in shape and of sufficient size to fit securely within cassette 351 (see FIG. 39). Hub 350 may optionally be co-molded or otherwise structurally integrated with cassette 351. Pawl 358 is flexibly mounted on body 352. A first end 362 of pawl 358 is fixedly attached to body 352. A second end 364 of pawl 358 includes a projection 366 that engages grooves 368 between teeth 370 in cassette 351 (see FIG. 39) to allow cassette 351 to be removed from a metering system while retaining mechanical memory of the next unused test sensor 130 positioned in cassette 351.

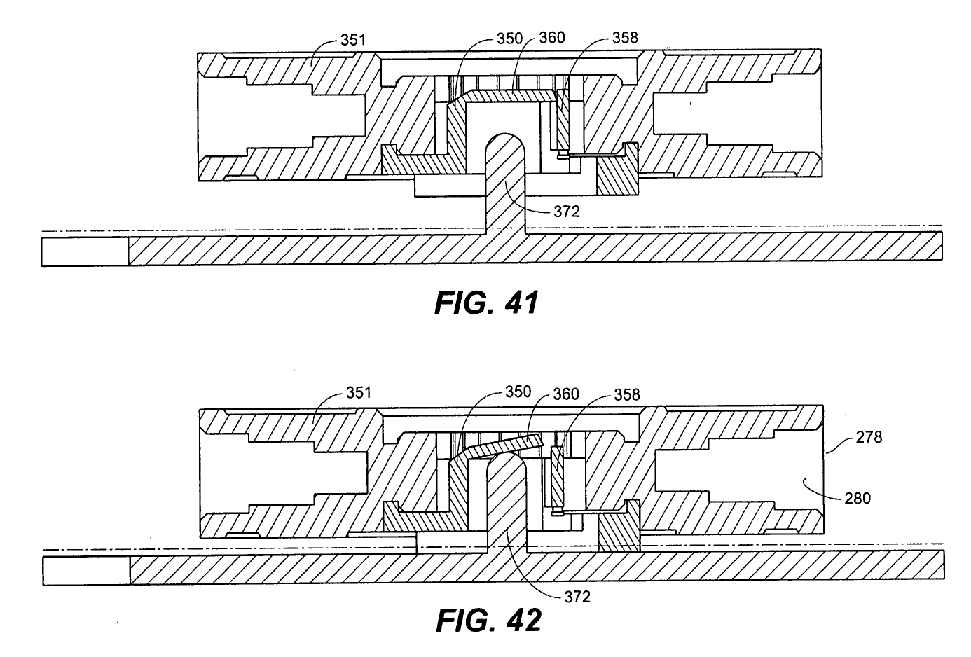

FIG. 41 is a cross-sectional view of hub 350 engaged or locked with cassette 351 and partially removed from a metering system. When hub 350 is engaged, cassette 351 can preferably rotate in only one direction within the metering system. Tongue 360 is pushed against pawl 358 (see FIG. 43) and protrusion 366 is engaged with groove 368 between teeth 370 (see FIG. 39). Engagement of pawl 358 with groove 368 preserves the position of cassette 351 upon removal from the metering system. When cassette 351 is inserted back into the metering system, the next unused test sensor 130 is presented in the proper orientation for use.

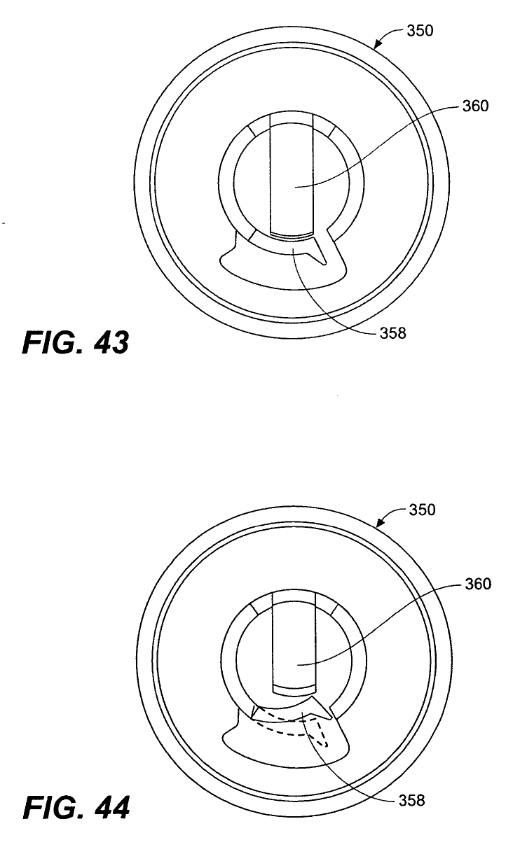

A cross-sectional view of hub 350 disengaged or unlocked from cassette 351 is illustrated in FIG. 42. When hub is disengaged, cassette 351 may have been used to dispense a portion of its available test sensors. This involves rotation of cassette 351 from an initial position in which a given opening 280 in a chamber 278 to a second position in which the same opening 280 has rotated by the angular separation of one opening 280 from the next. Thus, when the hub 350 and cartridge 351 are reconnected by re-engaging hub 350 within cassette 351, the relative angular position of hub 350 and cassette 351 will have changed and will be locked. As long as the initial relative angular position is known, the number of test sensors 130 dispensed can be determined by metering the system from cassette 351 itself after removal and subsequent reinsertion into the metering system. This form of mechanical memory is provided by disengaging pawl 358 (see FIG. 44) from groove 368 (teeth 370 may be viewed as an inwardly facing gear) by pushing tongue 360 up toward distal end 356 of hub 350 with an arm 372 of the metering system. When tongue 360 is pushed up toward distal end 356 of hub 350, cassette 351 can rotate relative to hub 350.

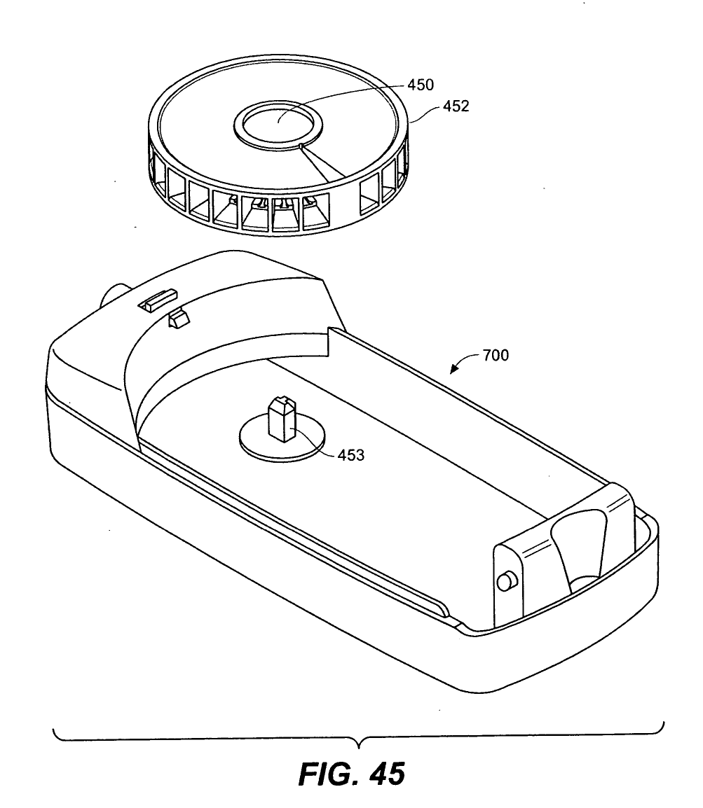

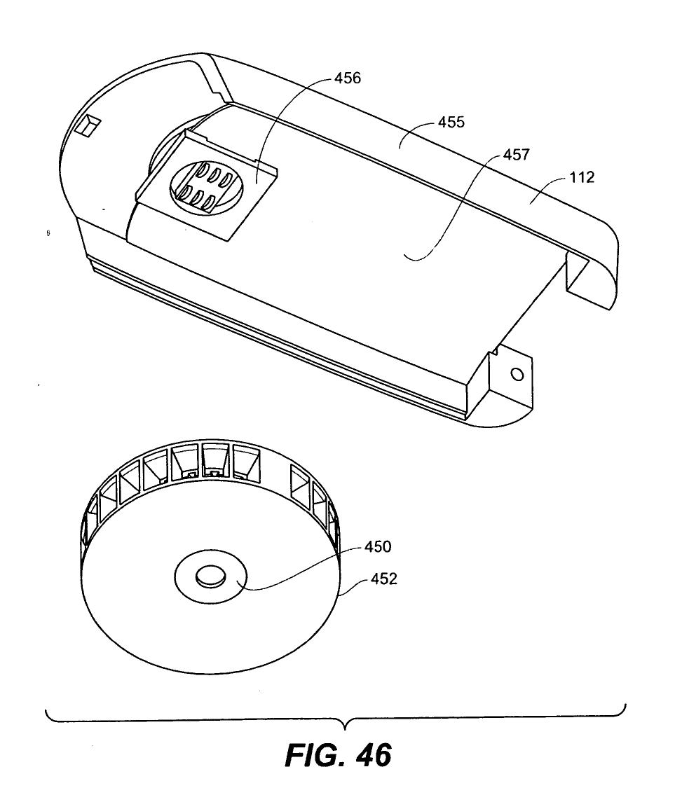

FIGS. 45 to 54 illustrate a hub 450 and an exemplary metering system 700 in which it can be installed and used according to another exemplary embodiment of the present invention. FIG. 45 is a perspective view of a cassette 452 with hub 450 engaged therein in a locking configuration and in preparation for insertion into a metering system. Upper casing 455 of metering system 700 has been removed for clarity and is shown in FIG. 46. A post 453 for engaging hub 450 is included in metering system 700 as will be described in more detail below. Upper casing 455 (see FIG. 46) includes a bearing 456 attached to an internal surface 457 for engaging with hub 450.

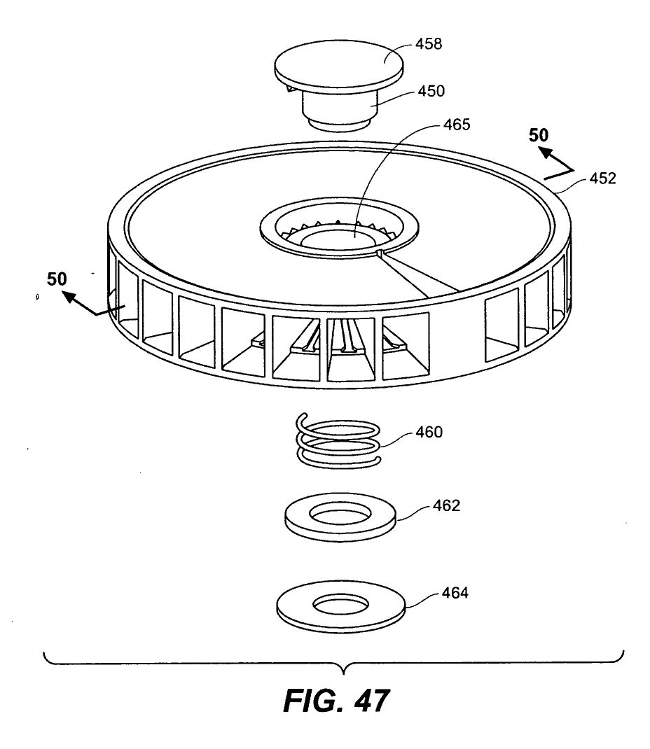

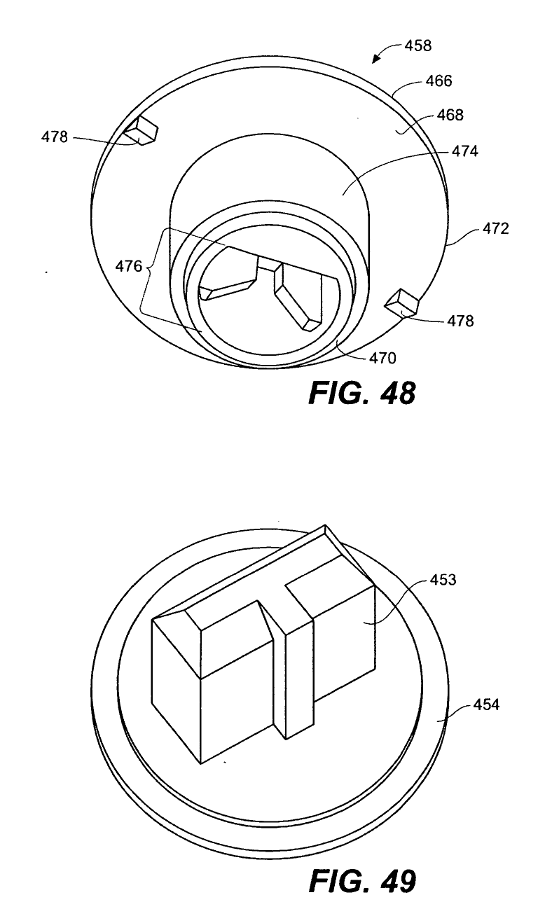

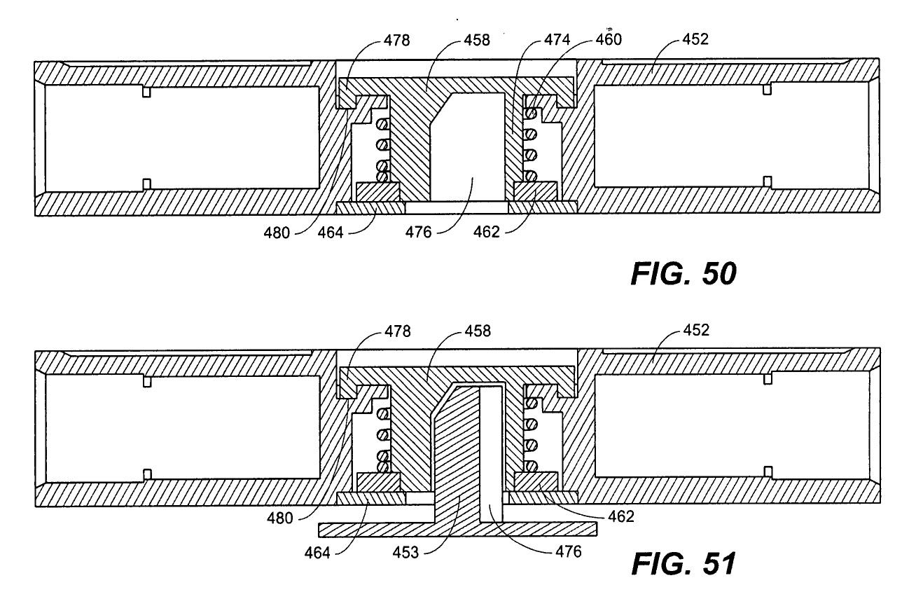

Referring to FIG. 47, hub 450 includes a cap 458, a spring 460, a retainer 462 and an optional plug 464. When assembled hub 450 will be removably engaged in an aperture 465 of cassette 452. Hub 450 is preferably cylindrical in shape and of sufficient size to fit securely within cassette 452. Hub 450 may optionally be co-molded with cassette 452. Referring to FIG. 48, cap 458 includes a distal end 466 with a lip 468, a proximal end 470 for engaging with post 453 of metering system 700, and a body 472 with a projection 474 containing a keyway 476 therein. Keyway 476 mates with post 453 in metering system 100. Post 453 is optionally T-shaped (see FIG. 49) and is mounted on a base 454. Cap 458 further includes at least two teeth 478 for engaging with at least two indentations 480 (see FIG. 50) on an upper surface of cassette 452. Spring 460 surrounds cylindrically shaped projection 474. Retainer 462 is securely attached to proximal end 470 of cap 458 to retain spring 460 around projection 474. Plug 464 is secured to the lower surface 457 of cassette 452 to reduce intentional and unintentional tampering with hub 450.

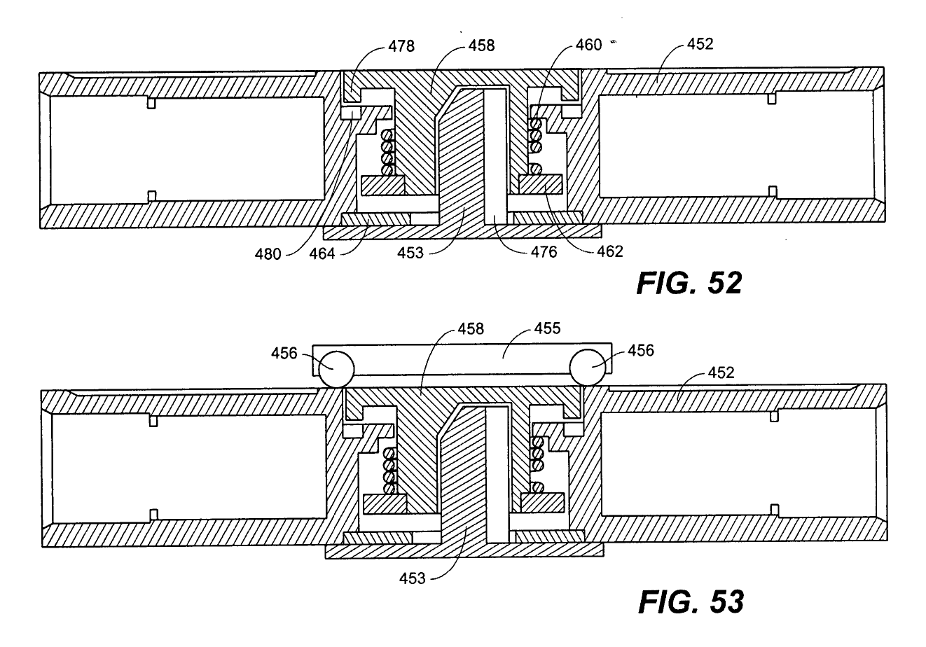

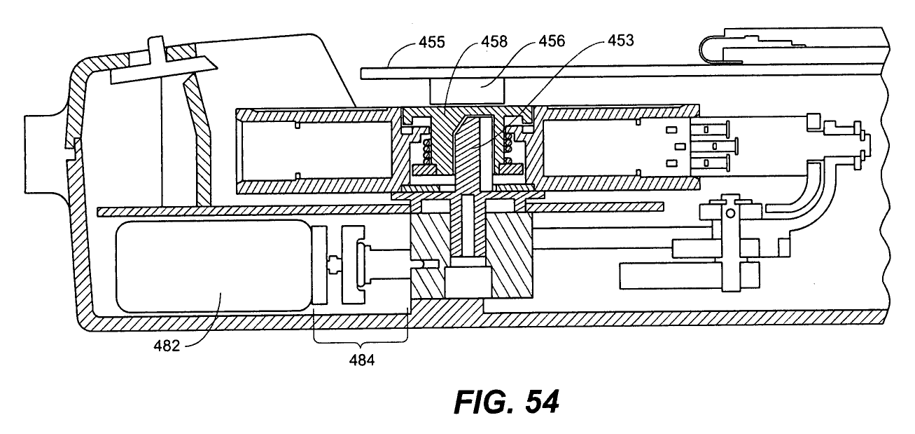

FIG. 50 illustrates cap 458 in a locked position when cassette 452 is removed from metering system 700. In this position, teeth 478 are engaged with indentations 480 in the upper surface of cassette 452 such that cap 458 cannot rotate and keyway 476 position is maintained. In this way, each of teeth 478 function like a pawl and indentations 480 function like teeth in accordance with the present invention. When cassette 452 is placed back into metering system 700, keyway 476 will only fit into metering system in one orientation, i.e., in the position at which cassette 452 was removed. Keyway 476 mates with post 453 as shown in FIG. 51. FIG. 52 illustrates when cassette 452 is inserted back into metering system 700 and keyway 476 of cap 458 is engaged by post 453 such that cap 458 is pushed up and teeth 478 are disengaged from indentations 480. Cassette 452 may now be moved to the next available unused test sensor by a moving means (e.g., a motor 482 and a plurality of gears 484 as shown in FIG. 54) within metering system 700. When upper casing 455 of metering system 700 is closed, bearing 456 exerts a downward force on cassette 452 to hold cassette 452 in place (see FIG. 53).

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A cassette assembly for use with an analyte measurement system, the cassette assembly comprising:
a disk that can hold a plurality of test sensors and a hub about which the disk can rotate; and
a locking mechanism integrated with the hub and disk and selectively configurable between a first configuration that prevents relative rotational movement between the hub and disk and a second configuration that allows relative rotational movement between the hub and disk.

2. The cassette assembly of claim 1, wherein the hub comprises a pawl releasably engageable with a tooth of the disk.

3. The cassette assembly of claim 2, wherein the disk comprises a plurality of teeth.

4. The cassette assembly of claim 3, comprising an anti-reverse mechanism comprising the pawl of the hub and the plurality of teeth of the disk.

5. The cassette assembly of claim 2, wherein in the first configuration the locking mechanism includes a movable portion positioned relative to the pawl so that the pawl cannot move to disengage from the tooth.

6. The cassette assembly of claim 5, wherein the moveable portion comprises a moveable element distinct from the hub.

7. The cassette assembly of claim 5, wherein the moveable portion comprises an arm of the hub bendably moveable relative to the hub.

8. The cassette assembly of claim 1, wherein the disk comprises a plurality of test sensors.

9. The cassette assembly of claim 1 in combination with an analyte measurement system.

10. The combination of claim 9, wherein the cassette assembly is installed in the analyte measurement system and the locking mechanism is the second configuration so that the disk can rotate relative to the hub as driven by the analyte measurement system.

11. A cassette assembly for use with an analyte measurement system, the cassette assembly comprising:
a disk that can hold a plurality of test sensors and a hub about which the disk can rotate;
a locking mechanism integrated with the hub and disk and selectively configurable between a first configuration that prevents relative rotational movement between the hub and disk and a second configuration that allows relative rotational movement between the hub and disk; and
an electronic chip incorporated with the hub.

12. The cassette assembly of claim 11, wherein the electronic chip comprises a memory module.

13. The cassette assembly of claim 12, wherein the disk comprises a plurality of test sensors.

14. The cassette assembly of claim 13, wherein the memory module comprises information related to the plurality of test sensors.

15. A method of maintaining the position of a test sensor of a cassette assembly relative to an analyte measurement system when the cassette assembly is removed from the analyte measurement system, the method comprising the steps of:
providing an analyte measurement system having a cassette assembly installed therein, the cassette assembly comprising a disk and a hub, the disk comprising a test sensor in a storage position rotationally positioned relative to the hub;
removing the cassette assembly from the analyte measurement system; and
engaging a locking mechanism of the cassette assembly that locks the relative rotational position of the disk and hub.

16. The method of claim 15, comprising engaging a pawl of the hub with a tooth of the disk.

17. The method of claim 16, comprising positioning a stopper relative to the pawl of the hub so that the pawl cannot move out of engagement with the tooth of the disk.

18. The method of claim 15, comprising reinserting the cassette assembly into the analyte measurement system after the removing and engaging step.

19. An analyte measurement system comprising:
a cassette assembly having a disk rotatably mounted on a hub for providing a plurality of test sensors;
an arm pivotable about the hub, the arm having a pawl that can drivingly engage a tooth of the disk of the cassette assembly; and
a carriage having an engaging device that can engage with the arm during a first movement of the carriage to index the disk of the cassette assembly and thereafter disengage with the arm during a second movement of the carriage.

20. The system of claim 19, wherein the carriage is drivable to a position where an connector of the carriage can engage with a test sensor in the disk of the cassette assembly.

21. The system of claim 19, wherein the pawl comprises an extension portion of the arm that can flex relative to the arm.

22. The system of claim 19, comprising a wire connected to the arm at a first end and engageable with the carriage at a second end.

23. The system of claim 22, wherein the engaging device comprises a ramp that can guide the second end of the wire to a groove of the engaging device when the carriage is moved relative to the wire.

24. A method of indexing a cassette in an analyte measurement system, the method comprising the steps of:
providing a rotatable cassette;
engaging a tooth of the cassette with a pawl, the pawl having an extension portion;
driving a carriage in a first direction toward an end of the extension portion of the pawl;
guiding the end of the extension portion of the pawl with a ramp of the carriage while the carriage is driven in the first direction;
driving the carriage in a second direction opposite the first direction to engage the end of the extension portion of the pawl with the carriage; and
driving the carriage in the second direction to index the cassette with the pawl.

25. The method of claim 24, comprising disengaging the extension portion of the pawl from the carriage after indexing the cassette by driving the carriage in the first direction.
